(19) United States
(12) Patent Application Publication
(10) Pub. No.: US 2026/0117051 A1
(43) Pub. Date: Apr. 30, 2026

(54) AMMONIUM POLYPHOSPHATE PARTICLES AS A FLAME RETARDANT IN POLYURETHANE FOAMS

(71) Applicant: UNIVERSITEIT TWENTE, Enschede (NL)

(72) Inventors: Stefan PEIL, Enschede (NL); Frederik Roman WURM, Enschede (NL); Rolf ALBACH, Leverkusen (DE); Thomas HOLTEY, Leverkusen (DE); Sivathmeehan YOGENDRA, Leverkusen (DE); Alfred SCHULZ, Leverkusen (DE)

(21) Appl. No.: 19/165,817

(22) PCT Filed: Mar. 14, 2024
(86) PCT No.: PCT/EP2024/056809

§ 371 Date: Sep. 16, 2025

(30) Foreign Application Priority Data
Mar. 16, 2023 (NL) 2034364

(51) Int. Cl. C08K 9/10; B01J 13/16; C08K 5/3492; C08L 75/08

(52) U.S. Cl. CPC C08K 9/10; B01J 13/16; C08K 5/34922; C08L 75/08; C08L 2201/02; C08L 2203/14; C08L 2205/025

(57) ABSTRACT

Particles having a core including a water-soluble ammonium polyphosphate and a shell including polyphenols, and to the use of these particles as flame retardants, in particular in polyurethane foams.

### FIELD OF THE INVENTION

The present invention relates to particles comprising a core comprising a water-soluble ammonium polyphosphate and a shell comprising polyphenols, to the use of these particles as flame retardants, to a method for producing polyurethane foams with these particles, to a polyurethane foam comprising the particles, and to the use of such a polyurethane foam.

### BACKGROUND OF THE INVENTION

Like all organic polymers, polyurethane foams are flammable, and the large surface area per unit mass in foams exacerbates this behaviour. Polyurethane foams are used, for example, in the furniture industry as seat cushions or generally as noise and heat insulation materials. In many applications of polyurethane foams, fire protection is therefore required in the form of added flame retardants. There are flame retardants that smother the flame in the gas phase and there are flame retardants that protect the surface of the polymeric material by promoting charring or forming a glassy coating. Halogen-containing compounds and nitrogen and phosphorus compounds are the preferred flame retardants. Compounds containing halogens and low-valent phosphorus compounds are considered typical representatives of flame retardants that smother flames. Higher-valent phosphorus compounds are said to cause catalytic cleavage of polyurethanes, leading to the formation of a solid, polyphosphate-containing charred surface. This intumescent layer protects the material from further combustion.

Usually, mixtures of flame retardants are used to reduce the flammability of polyurethane foams. For example, for flexible polyurethane foams mixtures of phosphoric trichloropropyl ester (TCPP), phosphoric tris(dichloropropyl) ester (TDCPP) and/or melamine are used.

A disadvantage of using melamine is that it is not harmless to health and, as a solid, is insoluble in the raw materials used to make polyurethanes. Stirring powder into the liquid polyurethane raw materials and its tendency to sedimentation therefore make industrial processing difficult. Liquid flame retardants such as TCPP do not have this disadvantage. On the contrary, compounds such as TCPP are relatively volatile and thus able to interfere with the radical chain reaction taking place in a flame. This results in the temperature of the flame being reduced, which in turn reduces the decomposition of the ignited material. However, one disadvantage of the halogen-containing representatives of these classes in particular is that they can also migrate out of the foam due to their volatility, and produce corrosive hydrohalic acid when used in a combustion process.

The disadvantages mentioned can be partially compensated for by the use of the well-known flame retardant ammonium polyphosphate (APP). The use of APP in combination with red phosphorus and optionally expanded graphite (EG) is disclosed, for example, in JP10147623 A2. However, APP also has disadvantages. For example, APP also sediments in polyurethane raw materials and its ammonium ions are in equilibrium with the tertiary amines used to catalyze the reactions of isocyanates. This can affect the reaction rate in polyurethane production. To reduce this effect, protective coatings are applied to the APP particles. For example, CN104817676 discloses particles with an APP core and a shell of melamine-based polymers. CN104448394 describes the use of hydroxy-functional acrylates as a shell. However, the large number of isocyanate reactive groups on the surface of the shell results in a high cross-link density, which can compromise elasticity of the polyurethane.

### SUMMARY OF THE INVENTION

It is an object of the present invention to provide a sedimentation-stable flame retardant which leads to improved flame retardancy, particularly in polyurethane foams. Preferably, the use of the sedimentation-stable flame retardant can reduce or even substitute the amount of halogen-containing flame retardants.

Thereto, the present invention provides particles comprising, preferably consisting of a core comprising a water-soluble ammonium polyphosphate and a shell comprising polyphenols, preferably bio-based polyphenols. The invention relates to the preparation process for these particles, dispersions of these particles in an isocyanate-reactive matrix and the use of these particles as flame retardants. The particles according to the invention are preferably used in polyurethanes as flame retardants, preferably in polyurethane foams.

Thus, the present invention further provides: a dispersion comprising, preferably consisting of, the particles in an isocyanate-reactive matrix; a method for producing the particles, and use of the particles as flame retardants.

The present invention also provides a method for producing polyurethane foams, preferably crosslinked polyurethane foams, wherein the components
A comprising
A1 one or more compounds with hydrogen atoms which are reactive towards isocyanates,
A2 a blowing agent,
A3 a flame retardant, and optionally
A4 excipients and/or additives
   and
B a polyisocyanate,
are reacted with one another, wherein the flame retardant A3 comprises particles according to the invention as component A3.1.

The present invention also provides a polyurethane foam produced by the method according to the invention, and for use of the polyurethane foam to produce shaped articles, such as for example furniture upholstery, textile inserts, mattresses, automobile seats, headrests, armrests, sponges, headliners, door panels, seat covers or construction elements.

### Particles

The particles according to the invention comprise, preferably consist of, a core comprising a water-soluble ammonium polyphosphate and a shell comprising polyphenols. The proportion of the core in the particle is preferably in the range from 65 to 95% by weight and the proportion of the shell from 5 to 35% by weight, based on the total weight of the core and the shell of the particles. More preferably, the amount of the core amounts to 66-90%, such as 67-85%, by weight and the amount of the shell to 10-34%, such as 15-33% by weight, based on the total weight of the core and the shell of the particles.

Preferably, the ammonium polyphosphate of the core of the particles corresponds to formula (I).

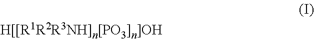

wherein R¹ to R³ each independently represent H or a substituted or unsubstituted alkyl group, preferably an alkyl group having 1 to 8 carbon atoms, and n is an integer from 4 to 20.

Particularly preferred are water-soluble ammonium polyphosphates according to formula (I) in which R¹ to R³ independently represent H, CH₃ or CH₂CH₃ and n is an integer from 4 to 20. Preferably, the ammonium polyphosphate (APP) is phase I APP (i.e. linear or non-branched APP). Preferably, the ammonium polyphosphate has a water solubility of at least 1 g/mL @ 25° C., more preferably of at least 1.2 g/mL @ 25° C. The P₂O₅ content of the polyphosphate is preferably between 50 and 70 wt. %, more preferably between 55 and 65 wt. %. The nitrogen content of the polyphosphate is preferably between 15 and 25 wt. %, more preferably between 15 and 20 wt. %. Preferably, the polyphosphate has pH value of between 5.5 and 7.5 for a 1% solution in water (w/v with respect to total solution volume), more preferably between 6.7 and 7.0. Solubility values given are at 25° C. unless defined otherwise.

In addition to ammonium polyphosphate, the core may contain other compounds, for example from the group of phosphates, phosphinates or phosphonates. However, it is preferred if the core contains 50 to 100% by weight of ammonium polyphosphate, particularly preferably 75 to 100% by weight and most preferably 100% by weight.

The shell of the particles comprises polyphenols which preferably comprise structural units derived from lignin, more preferably kraft lignins or lignosulfonates, most preferably lignosulfonates. Polyphenols can be active as antioxidants and thus may support the action of polyphosphate.

Kraft lignins are by-products from the Kraft process. Lignosulfonates (LS) are sulfonated lignin by-products from the production of wood pulp using sulfite pulping. Due to the presence of the sulfonated group, lignosulfonates are negatively charged and typically water soluble at pH between 6.0-8.0. Lignosulfonates have very broad ranges of number average molecular weight Mn (i.e. they are very polydisperse), for example in the range of from 1,000-140,000 Da. LS are non-toxic, non-corrosive, and biodegradable. Kraft lignin generally has a lower water solubility at pH between 6.0 and 8.0, due to the lower degree of sulfonation. However, Kraft lignins are soluble at basic pH above 8.5.

Preferably, the lignosulfonates have a water solubility at pH between 6.0 and 8.0 of at least 5 wt. %, such as at least 7 wt. %, preferably at least 10 wt. % relative to the weight of the total solution. Preferably, the lignosulfonates have at least 8 mmol/g of hydroxyl groups, more preferably at least 13 mmol/g, such as at least 18 mmol/g.

In a preferred embodiment, the shell of the particles is substantially free of melamine, acrylate and hydrophobic silicone. In this case, the term substantially may be read as being free from any detectable and/or functional amount of melamine, acrylate and hydrophobic silicone. Preferably, the shell comprises less than 100 ppm by weight, more preferably less than 10 ppm by weight, and most preferably less than 1 ppm by weight of melamine, acrylate and silicone.

The invention also provides a method for producing particles of the invention, the method comprising:
preparing an inverse emulsion of polyphenols, ammonium polyphosphate, emulsifier and water in an organic solvent, and subsequently
cross-linking the polyphenol with a crosslinker,
optionally followed by removing the organic solvent.

For example, the inverse emulsion (i.e. water-in-oil emulsion) may be prepared by first dissolving the polyphenols and ammonium polyphosphate in water, and preparing a solution of the emulsifier in the organic solvent, combining both solutions to form a two-phase mixture, and subsequently emulsifying the two-phase mixture.

Preferably, the amount of the water-soluble flame retardant amounts to 65-95%, such as 66-90%, preferably 67-85% by weight and the amount of the polyphenol to 5-35%, such as 10-34%, preferably 15-33% by weight, based on the total weight of the water-soluble flame retardant and the polyphenols.

In order to obtain a uniform droplet size, emulsification may for example be executed by ultrasonic emulsification, by emulsification with a microfluidizer, or by emulsification with a rotor-stator system.

Cross-linking of the polyphenols to yield the particles of the invention may subsequently be performed by adding a solution of a cross-linker in a second organic solvent, wherein the second organic solvent is miscible with the organic solvent of the inverse emulsion, more preferably wherein the second organic solvent is the same solvent as used for preparing the inverse emulsion.

Due to preparation of particles in an emulsion, particles will have a substantially spherical shape. Thus, preferably, the particles have a substantially spherical shape. By substantially spherical, it is meant that the particles possess a three-dimension geometry resembling a sphere, and the largest diameter does not differ by more than 20 percent, preferably not more than 10 percent, from the smallest diameter, based on the smallest diameter. Thus, the term “substantially spherical” is intended to encompass minor deviations from a perfect sphere, allowing for manufacturing tolerances and other variations, provided that such deviations do not exceed 20 percent, preferably 10 percent, of the smallest diameter. The size distribution of the particles is controllable via 3 parameters. First, the amount of the emulsifier determines the minimum droplet sizes which can be achieved in the emulsification step. Less emulsifier results in larger droplet sizes. The droplet size determines the size of the final particles. Furthermore, the processing parameters during emulsification are of influence. For example, for microfluidization, these parameters are the number of runs, wherein more runs lead to a more uniform particle distribution, and the applied pressure, wherein a higher pressure typically leads to smaller droplets and thus smaller particles. The skilled person knows how to alter the parameters in order to arrive at a desired particle distribution.

The size of the particles is preferably between 50 nm-100 μm, more preferably between 100 nm-1 μm, most preferably between 150 nm-250 nm. Alternatively, the size of the particles may be between 50-500 nm. The size is preferably measured by DLS, for example according to ISO 22412:2008, or by the method disclosed under characterization hereinbelow. Alternatively, the size may be determined by TEM, by measuring the average diameter of the dried particles, for example by the method disclosed under characterization herein below. In case of a particle which is not perfectly spherical, the diameter of a particle as measured by TEM is the largest measured diameter.

Particles with smaller sizes can be added in smaller amounts (by weight) to achieve the desired flame retardant properties as compared to larger particles. Without being bound by theory, it is believed that smaller particles result in a more uniform distribution of the flame retardant, and therefore better flame retardant properties at the same amount of particles. The polydispersity index (PDI) is preferably lower than 0.5, preferably lower than 0.25, most preferably lower than 0.2, such as between 0.05 and 0.15.

The organic solvent is not miscible with water, i.e. preferably has a water solubility of less than 100 g/dm³ of water, more preferably less than 5 g/dm³ of water at 25° C., and is preferably a solvent which is able to dissolve component A1 and that may easily be separated from the cross-linked particles by evaporation, such as a solvent which has a boiling point at atmospheric pressure below 150° C., preferably below 120° C., and more preferably below 81° C. In a most preferred embodiment, the organic solvent is cyclohexane or toluene.

The hydrophilic-lipophilic balance of an emulsifier is a measure of the degree to which it is hydrophilic or lipophilic, and is defined as HLB=20 Mₕ/M, wherein Mₕ is the molecular mass of the hydrophilic portion of the molecule, and M is the molecular mass of the whole molecule, giving a result on a scale of 0 to 20. In principle, any non-ionic emulsifier with an HLB value low enough to generate a stable water-in-oil emulsion may be used as the emulsifier. The emulsifier is preferably added in an amount ranging from 0.1% to 8.0%, more preferably 0.5% to 6%, even more preferably 1.0 to 4.0%, most preferably 1.5% to 3.5% (w/v), based on the amount of organic phase. The emulsifier is preferably an emulsifier with an HLB value of at most 7, more preferably the emulsifier is polyglycerol polyricinoleate (PGPR, E476). Preferably, the PGPR has a polymerization degree of between 1-10, more preferably between 1-4.

The crosslinker is preferably a polyisocyanate, such as an aliphatic, cycloaliphatic, araliphatic, aromatic or heterocyclic polyisocyanate, for example those corresponding to formula (II)

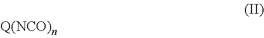

wherein n is an integer between 2-4, preferably 2 or 3, and Q is an aliphatic hydrocarbon radical having 2-18, preferably 6-10 C atoms, a cycloaliphatic hydrocarbon radical having 4-15, preferably 6-13 C atoms, an aromatic hydrocarbon radical having 6-10 C atoms, or an araliphatic hydrocarbon radical having 8-15, preferably 8-13 C atoms.

Particularly preferred are the technically easily accessible polyisocyanates, e.g. 2,4- and 2,6-toluylene diisocyanate, as well as any mixtures of these isomers (“TDI”); polyphenylpolymethylene polyisocyanates such as are prepared by aniline-formaldehyde condensation followed by phosgenation (“crude MDI”) and polyisocyanates comprising carbodiimide groups, urethane groups, allophanate groups, isocyanurate groups, urea groups or biuret groups (“modified polyisocyanates” or “prepolymers”), in particular modified polyisocyanates which derive from 2,4- and/or 2,6-toluylene diisocyanate and/or from diphenylmethane 4,4′- and/or 2,4′ and/or 2,2′-diisocyanate. Preferably, at least one compound selected from the group consisting of 2,4- and 2,6-toluylene diisocyanate, diphenylmethane 4,4′- and 2,4′- and 2,2′-diisocyanate and polyphenylpolymethylene polyisocyanate (“multinuclear MDI”) is used as a crosslinker.

The mixtures of diphenylmethane diisocyanate and polyphenylene polymethylene polyisocyanate (“multinuclear MDI” or “pMDI”) have a preferred monomer content of between 50 and 100 wt. %, preferably between 60 and 95 wt. %, particularly preferably between 75 and 90 wt. %. The NCO content of the polyisocyanate used should preferably be above 25 wt. %, preferably above 30 wt. %, particularly preferably above 31.4 wt. %. Preferably, the MDI used should have a 2,4′-diphenylmethane diisocyanate content of at least 3% by weight, preferably at least 15% by weight.

In addition to the polyisocyanates mentioned above, it is also possible to co-use proportions of modified diisocyanates having uretdione, isocyanurate, urethane, carbodiimide, uretonimine, allophanate, biuret, amide, iminooxadiazinedione and/or oxadiazine trione groups as well as unmodified polyisocyanate with more than 2 NCO groups per molecule, such as 4-isocyanatomethyl-1,8-octane diisocyanate (nonane triisocyanate) or triphenylmethane-4,4′,4″-triisocyanate.

The particles produced after crosslinking the polyphenol with the crosslinker are easily dispersible in polymer matrices with a chemistry that is comparable to that of the polyphenol or the emulsifier.

The dispersion might be stabilized by the reaction of an excess of isocyanate groups in the shell of the particle with an isocyanate-reactive matrix.

The particles are preferably used in a dispersion of an isocyanate-reactive matrix as an inorganic-organic polymer polyol. The isocyanate-reactive matrix may, for example, comprise compounds of component A1. The proportion of the particles in such a dispersion is preferably 1 to 50 wt. %, preferably 5-25 wt. %, particularly preferably 7 to 19 wt. % relative to the total weight of the dispersion of particles in the isocyanate-reactive matrix.

In order to obtain the dispersion, the isocyanate-reactive matrix (i.e. component A1) may be added to the inverse emulsion, after which the solvent may be evaporated. Alternatively, though less preferably, the solvent may first be evaporated, after which the particles are added to the isocyanate-reactive matrix.

### Component A1

As compounds containing hydrogen atoms reactive to isocyanate, for example polyols selected from the group consisting of polyether polyols, polyester polyols, polyether ester polyols, polycarbonate polyols and polyether polycarbonate polyols can be used. Polyester polyols and/or polyether polyols are preferred. The compounds of component A1 may have an amine and/or hydroxyl number between 15 to 4000 mg KOH/g and a functionality of 1 to 8.

“Functionality” in the context of the present invention refers to the theoretical average functionality (number of groups in the molecule that are reactive towards isocyanates or towards polyols) calculated from the known feedstocks and their quantity ratios.

Preferably, the compounds of component A1 have a number average molecular weight of 2000 g/mol to 15000 g/mol, preferably 3000 g/mol to 12000 g/mol and particularly preferably 3500 g/mol to 6500 g/mol. If more than one compound of component A1 is used, the mixture of compounds of component A1 may preferably have a hydroxyl number between 20 to 200 mg KOH/g, in particular 25 to 100 mg KOH/g.

The compounds of component A1 are preferably compatible with the solvent of the outer phase of the particle dispersion. Most preferably, they are freely soluble in cyclohexane and/or toluene.

The number average molecular weight Mn (also: molecular weight) is determined in the context of the present invention by gel permeation chromatography according to DIN 55672-1 (August 2007).

Usable polyether ester polyols according to component A1 are preferably compounds containing ether groups, ester groups and OH groups. Preferably, organic dicarboxylic acids with up to 12 carbon atoms are used to prepare the polyether ester polyols, preferably aliphatic dicarboxylic acids with 4 to 6 carbon atoms or aromatic dicarboxylic acids, which are used individually or in a mixture. Examples include succinic acid, azelaic acid, decanedicarboxylic acid, malonic acid, phthalic acid, pimelic acid and sebacic acid, and in particular glutaric acid, fumaric acid, succinic acid, adipic acid, phthalic acid, terephthalic acid and isophthalic acid. In addition to organic dicarboxylic acids, derivatives of these acids, for example their anhydrides and their esters and half esters with low molecular weight, monofunctional alcohols containing 1 to 4 carbon atoms, can also be used. The proportionate use of biobased starting materials, in particular fatty acids or fatty acid derivatives (oleic acid, soybean oil, etc.) is also possible and may have advantages, e.g. with regard to storage stability of the polyol formulation, dimensional stability, fire behavior and compressive strength of the foams.

Polyether polyols obtained by alkoxylating starter molecules such as polyhydric alcohols may be used as further components for the production of the polyether ester polyols. The starter molecules are at least difunctional, but may optionally also contain proportions of higher-functional, in particular trifunctional, starter molecules.

Starter molecules are, for example, ethylene glycol, propylene glycol, 1,3-butanediol, 1,4-butanediol, 1,5-pentenediol, 1,5-pentanediol, 1,6-hexanediol, 1,7-heptanediol, 1,8-octanediol, 1,10-decanediol, 2-methylpropane-1,3-diol, neopentyl glycol, 2,2-dimethyl-1,3-propanediol, 3-methyl-1,5-pentanediol, 2-butyl-2-ethyl-1,3-propanediol, 2-butene-1,4-diol and 2-butyne-1,4-diol, diethylene glycol, dipropylene glycol, glycerol, trimethylolpropane, di- and tri-functional polyether polyols. The polyether polyols preferably have an OH functionality of 2 to 4 and a molecular weight Mn in the range of 62 to 4500 g/mol and in particular a molecular weight Mn in the range of 62 to 3000 g/mol. Starter molecules with functionalities different from OH can also be used alone or in mixture.

Polyether ester polyols can also be prepared by the alkoxylation, in particular by ethoxylation and/or propoxylation, of reaction products obtained by the reaction of organic dicarboxylic acids and their derivatives as well as components with Zerewitinoff-active hydrogens, in particular diols and polyols. As derivatives of these acids, for example, their anhydrides can be used.

The polyester polyols of component A1 can, for example, be polycondensates of polyhydric alcohols, preferably diols, with 2 to 12 carbon atoms, preferably with 2 to 6 carbon atoms, and polycarboxylic acids, such as di-, tri- or even tetracarboxylic acids or hydroxycarboxylic acids or lactones. Preferably aromatic dicarboxylic acids or mixtures of aromatic and aliphatic dicarboxylic acids are used. Instead of the free polycarboxylic acids, the corresponding polycarboxylic acid anhydrides or corresponding polycarboxylic acid esters of lower alcohols can also be used to prepare the polyesters.

Carboxylic acids that can be considered in particular are: Succinic acid, glutaric acid, adipic acid, corkic acid, azelaic acid, sebacic acid, decandicarboxylic acid, tetrahydrophthalic acid, hexahydrophthalic acid, cyclohexanedicarboxylic acid, tetrachlorophthalic acid, itaconic acid, malonic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, trimellitic acid, benzoic acid, maleic acid, fumaric acid, phthalic acid, isophthalic acid and terephthalic acid. Derivatives of these carboxylic acids, such as dimethyl terephthalate, can also be used. The carboxylic acids can be used either individually or in mixtures. Preferred carboxylic acids are adipic acid, sebacic acid and/or succinic acid, particularly preferred are adipic acid and/or succinic acid.

Hydroxycarboxylic acids that can be co-used as reactants in the preparation of a polyester polyol having terminal hydroxyl groups include lactic acid, malic acid, hydroxycaproic acid, hydroxybutyric acid, hydroxydecanoic acid, hydroxystearic acid and the like. Suitable lactones include caprolactone, butyrolactone and homologs.

In particular, biobased starting materials and/or derivatives thereof are also suitable for the production of the polyester polyols, such as Castor oil, polyhydroxy fatty acids, ricinoleic acid, hydroxyl-modified oils, grape seed oil, black caraway seed oil, pumpkin seed oil, borage seed oil, soybean oil, wheat seed oil, rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, primrose oil, wild rose oil, safflower oil, walnut oil, fatty acids, hydroxyl-modified and epoxidized fatty acids and fatty acid esters, for example based on myristoleic acid, palmitoleic acid, oleic acid, vaccenic acid, petroselinic acid, gadoleic acid, erucic acid, nervonic acid, linoleic acid, alpha- and gamma-linolenic acid, stearidonic acid, arachidonic acid, timnodonic acid, clupanodonic acid and cervonic acid. In particular, esters of ricinoleic acid with polyhydric alcohols, e.g. glycerol, are preferred. Also preferred is the use of mixtures of such biobased acids with other carboxylic acids, e.g. phthalic acids.

Examples of suitable diols are ethylene glycol, butylene glycol, diethylene glycol, triethylene glycol, polyalkylene glycols such as polyethylene glycol, furthermore 1,2-propanediol, 1,3-propanediol, 1,3-butanediol, 1,4-butanediol, 1,6-hexanediol and isomers, neopentyl glycol or hydroxypivalic acid neopentyl glycol esters. Preferably, ethylene glycol, diethylene glycol, 1,4-butanediol, 1,5-pentanediol, 1,6-hexanediol or mixtures of at least two of the mentioned diols are used, in particular mixtures of 1,4-butanediol, 1,5-pentanediol and 1,6-hexanediol.

In addition, polyols such as for example trimethylolpropane, glycerol, erythritol, pentaerythritol, trimethylolbenzene or trishydroxyethylisocyanurate can also be used, with glycerol and trimethylolpropane being preferred.

Additional co-use of monohydric alkanols is also possible.

The polyether polyols of component A1 are obtained by production methods known to those skilled in the art, such as by anionic polymerization of one or more alkylene oxides having 2 to 4 carbon atoms with alkali hydroxides, such as sodium or potassium hydroxide, alkali alcoholates, such as sodium methylate, sodium or potassium ethylate or potassium isopropylate, or aminic alkoxylation catalysts, such as dimethylethanolamine (DMEA), imidazole and/or imidazole derivatives, or DMC catalysts using at least one initiator molecule containing 2 to 8, preferably 2 to 6, reactive hydrogen atoms bound.

Suitable alkylene oxides include tetrahydrofuran, 1,3-propylene oxide, 1,2- or 2,3-butylene oxide, styrene oxide, and preferably ethylene oxide and 1,2-propylene oxide. The alkylene oxides may be used singly, alternately in sequence, or as mixtures. Preferred alkylene oxides are propylene oxide and ethylene oxide, and copolymers of propylene oxide with ethylene oxide are particularly preferred. The alkylene oxides can be reacted in combination with CO₂.

Suitable starter molecules are, for example: Water, organic dicarboxylic acids, such as succinic acid, adipic acid, phthalic acid and terephthalic acid, aliphatic and aromatic, optionally N-mono-, N,N- and N,N′-dialkyl-substituted diamines with 1 to 4 carbon atoms in the alkyl radical, such as optionally mono- and dialkyl-substituted ethylenediamine, diethylenetriamine, triethylenetetramine, 1,3-propylenediamine, 1,3- or 1,4-butylenediamine, 1,2-, 1,3-, 1,4-, 1,5- and 1,6-hexamethylenediamine, phenylenediamines, 2,3-, 2,4- and 2,6-tolylenediamine and 2,2′-, 2,4′- and 4,4′-diaminodiphenylmethane.

Preferably used are dihydric or polyhydric alcohols, such as ethanediol, 1,2- and 1,3-propanediol, diethylene glycol, dipropylene glycol, 1,4-butanediol, 1,6-hexanediol, paraformaldehyde, triethanolamine, bisphenols, glycerol, trimethylolpropane, pentaerythritol, sorbitol and sucrose.

Usable polycarbonate polyols are polycarbonates containing hydroxyl groups, for example polycarbonate diols. These are formed in the reaction of carbonic acid derivatives, such as diphenyl carbonate, dimethyl carbonate or phosgene, with polyols, preferably diols.

Examples of such diols are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentanediol-1,3, dipropylene glycol, polypropylene glycols, dibutylene glycol, polybutylene glycols, bisphenols and lactone-modified diols of the above type.

Instead of or in addition to pure polycarbonate diols, polyether polycarbonate diols can also be used, which are obtainable, for example, by copolymerizing alkylene oxides, such as propylene oxide, with CO₂.

Polymer polyols, PHD polyols and PIPA polyols can also be used in component A1 as compounds with hydrogen atoms that are reactive towards isocyanates. Polymer polyols are polyols containing portions of polymers produced by polymerization of suitable monomers such as styrene or acrylonitrile in a base polyol. PHD (polyhydrazodicarbonamide) polyols are prepared, for example, by in situ polymerization of an isocyanate or an isocyanate mixture with a diamine and/or hydrazine (or hydrazine hydrate) in a polyol, preferably a polyether polyol. Preferably, the PHD dispersion is prepared by reacting an isocyanate mixture of 75 to 85 wt. % 2,4-toluylene diisocyanate (2,4-TDI) and 15 to 25 wt. % 2,6-toluylene diisocyanate (2,6-TDI) with a diamine and/or hydrazine hydrate in a polyether polyol prepared by alkoxylation of a trifunctional initiator (such as glycerol and/or trimethylolpropane). PIPA polyols are polyether polyols modified with alkanolamines by polyisocyanate polyaddition, the polyether polyol preferably having a functionality of 2.5 to 4.0 and a hydroxyl number of 3 mg KOH/g to 112 mg KOH/g (molecular weight 500 g/mol to 18000 g/mol).

Isocyanate-reactive substances with cell-opening activity can also be used, such as copolymers of ethylene oxide and propylene oxide with an excess of ethylene oxide or aromatic diamines such as diethyltoluenediamine.

In addition to the isocyanate-reactive compounds described above, component A1 may contain, for example, graft polyols, polyamines, polyamino alcohols and polythiols. The isocyanate-reactive components described also include such compounds with mixed functionalities.

For the production of polyurethane foams by a cold foam process, polyethers containing at least two hydroxyl groups and having an OH number of 20 to 50 mg KOH/g are preferably used, at least 80 mol % of the OH groups consisting of primary OH groups (determination by 1H-NMR (e.g. Bruker DPX 400, deuterochloroform)). Particularly preferably, the OH number is 25 to 40 mg KOH/g, most preferably 25 to 35 mg KOH/g.

Compounds with at least two hydrogen atoms reactive to isocyanates and an OH number of 280 to 4000 mg KOH/g, preferably 400 to 3000 mg KOH/g, particularly preferably 1000 to 2000 mg KOH/g, may additionally be used in component A1. This refers to compounds containing hydroxyl groups and/or amino groups and/or thiol groups and/or carboxyl groups, preferably compounds containing hydroxyl groups and/or amino groups, which serve as chain extenders or crosslinking agents. These compounds generally have 2 to 8, preferably 2 to 4, hydrogen atoms reactive with isocyanates. For example, ethanolamine, diethanolamine, triethanolamine, sorbitol and/or glycerol may be used.

Component A1 may comprise one or more of the above-mentioned isocyanate-reactive components, preferably component A1 comprises at least two hydroxyl group-containing polyethers, optionally in admixture with at least two hydroxyl group-containing polyesters.

In a preferred embodiment, component A1 comprises:
A1.1 compounds containing hydrogen atoms reactive towards isocyanates and having an NH number according to DIN 53176 in the version of November 2002 and/or OH number according to DIN 53240-1 in the version of June 2013 of 20 to <120 mg KOH/g,
   optionally
A1.2 compounds containing hydrogen atoms which are reactive towards isocyanates and having an NH number according to DIN 53176 in the version of November 2002, and/or an OH number according to DIN 53240-1 in the version of June 2013, of 120 to <600 mg KOH/g,
   and optionally
A1.3 compounds containing hydrogen atoms reactive toward isocyanates and having an NH number according to DIN 53176 in the version of November 2002 and/or OH number according to DIN 53240-1 in the version of June 2013 of 600 to 4000 mg KOH/g.

In a further preferred embodiment, component A1 contains at least 30% by weight, based on the total weight of component A1, of at least one polyoxyalkylene copolymer consisting of a starter, propylene oxide and ethylene oxide and a terminal block of ethylene oxide, the total weight of the terminal blocks of ethylene oxide being on average 3-20% by weight, preferably 5-15% by weight, particularly preferably 6-10% by weight, based on the total weight of all polyoxyalkylene copolymers.

### Component A2

Chemical and/or physical blowing agents are used as component A2.

For example, water or carboxylic acids and mixtures thereof are used as chemical blowing agent A2.1. These react with isocyanate groups to form the blowing gas, such as in the case of water, carbon dioxide is formed, and in the case of formic acid, for example, carbon dioxide and carbon monoxide are formed. Preferably, at least one compound selected from the group consisting of formic acid, N,N-dialkylcarbamic acid, oxalic acid, malonic acid and ricinoleic acid is used as the carboxylic acid. The ammonium salts of these acids are also suitable. Water is particularly preferred as chemical blowing agent.

As physical blowing agent A2.2 are used, for example, low-boiling organic compounds such as hydrocarbons, ethers, ketones, carboxylic acid esters, carbonic acid esters, halogenated hydrocarbons. Organic compounds which are inert to the isocyanate component B and have boiling points below 100° C., preferably below 50° C. at atmospheric pressure, are particularly suitable. These boiling points have the advantage that the organic compounds evaporate under the influence of an exothermic polyaddition reaction between components A1 and B. Examples of such preferably used organic compounds are alkanes, such as heptane, hexane, n- and iso-pentane, preferably technical mixtures of n- and iso-pentanes, n- and iso-butane and propane, cycloalkanes, such as cyclopentane and/or cyclohexane, ethers, such as furan, dimethyl ether and diethyl ether, ketones, such as acetone and methyl ethyl ketone, carboxylic acid alkyl esters, such as methyl formate, dimethyl oxalate and ethyl acetate, and halogenated hydrocarbons, such as methylene chloride, difluoromethane, trifluoromethane, difluoroethane, tetrafluoroethane, 1,1-dichloro-2,2,2-trifluoroethane, 2,2-dichloro-2-fluoroethane and heptafluoropropane. Also preferred is the use of (hydro)fluorinated olefins, such as HFO 1233zd(E) (trans-1-chloro-3,3,3-trifluoro-1-propene) or HFO 1336mzz(Z) (cis-1,1,1,4,4-hexafluoro-2-butene) or additives such as FA 188 from 3M (1,1,1,2,3,4,5,5-nonafluoro-4-(trifluoromethyl)pent-2-ene). Mixtures of two or more of the above organic compounds can also be used. In this context, the organic compounds may also be used in the form of an emulsion of small droplets.

Preferably, component A2 contains
A2.1 0.1 to 10 parts by weight, preferably 1 to 5 parts by weight. (in each case based on the sum of the parts by weight of all components A=100 parts by weight) chemical blowing agents
and/or
A2.2 0 to 15 parts by weight (based on the sum of the parts by weight of all components A=100 parts by weight) of physical blowing agents.

Water is particularly preferred as component A2.

### Component A3

The flame retardant A3 used comprises the particles of the invention as component A3.1.

The particles of component A3.1 can be used alone or as a mixture with further flame retardants A3.2. The proportion of component A3.1 in flame retardant A3 can be, for example, from 20% by weight to 100% by weight, preferably from 20% by weight to 80% by weight and particularly preferably from 20% by weight to 50% by weight, in each case based on the total mass of flame retardant A3. The proportion of particles of component A3.1 in the reaction mixture comprising components A1 to A4 without B can be, for example, >0 wt. % to 40 wt. %, preferably 2 wt. % to 30 wt. %, particularly preferably 4 wt. % to 15 wt. %. The proportion in wt. % of component A3.1 refers here to the particles of component A3.1 and not, for example, to the sum of the weight of particles A3.1 and a component A1 if a dispersion of particles of component A3.1 and a compound according to component A1 is used.

In addition to the particles of component A3.1, component A3 may contain further flame retardants A3.2 such as, for example, melamine, phosphates or phosphonates, such as diethyl ethane phosphonate (DEEP), triethyl phosphate (TEP) and dimethyl propyl phosphonate (DMPP). Other suitable flame retardants include brominated esters, brominated ethers (Ixol) or brominated alcohols such as dibromoneopentyl alcohol, tribromoneopentyl alcohol, tetrabromophthalate diol (DP 54) and PHT-4 diol, as well as chlorinated phosphates such as tris(2-chloroethyl) phosphate, tris(2-chloropropyl) phosphate (TCPP), tris(1,3-dichloropropyl) phosphate, tricresyl phosphate, diphenylcresyl phosphate (DPK), tris(2,3-dibromopropyl) phosphate, tetrakis(2-chloroethyl)ethylene diphosphate, dimethyl methane phosphonate, diethanolaminomethyl phosphonic acid diethyl ester, and commercially available halogen-containing flame retardant polyols.

Preferably component A3 does not contain substances that are classified as cancerogenic, mutagenic and/or toxic for reproduction or highly persistent.

Preferably, a mixture of particles according to component A3.1 and at least one compound of component A3.2 selected from melamine and halogenated phosphates, preferably melamine and TCPP, is used as flame retardant.

### Component A4

As component A4, excipients and/or additives may be used such as
a) catalysts (activators),
b) surface-active additives (surfactants), such as emulsifiers and foam stabilizers, especially those with low emission such as products of the Tegostab® LF series,
c) additives such as reaction retarders (e.g. acid-reacting substances such as hydrochloric acid or organic acid halides), cell regulators (such as kerosenes or fatty alcohols or dimethylpolysiloxanes), pigments, dyes, stabilizers against aging and weathering, plasticizers, fungistatic and bacteriostatic substances, fillers (such as barium sulfate, diatomaceous earth, carbon black or whiting) and release agents.

Preferred catalysts are aliphatic tertiary amines (for example triethylamine, tetramethylbutanediamine), cycloaliphatic tertiary amines (for example 1,4-diaza(2,2,2)bicyclooctane), aliphatic aminoethers (for example dimethylaminoethyl ether and N,N,N-trimethyl-N-hydroxyethyl-bisaminoethyl ether), cycloaliphatic aminoethers (for example N-ethylmorpholine), aliphatic amine oxides, aliphatic amidines, cycloaliphatic amidines, urea, derivatives of urea (such as aminoalkyl ureas), in particular (3-dimethylaminopropylamine) urea) and tin catalysts (such as dibutyltin oxide, dibutyltin dilaurate, tin octoate).

Particularly preferred catalysts are (i) urea, derivatives of urea and/or (ii) the above-mentioned amines and aminoethers, characterized in that the amines and aminoethers contain a functional group which reacts chemically with the isocyanate. Preferably, the functional group is a hydroxyl group, a primary or secondary amino group. These particularly preferred catalysts have the advantage that they exhibit greatly reduced migration and emission behavior. Examples of particularly preferred catalysts include (3-dimethylaminopropylamine)urea, 1,1′-((3-(dimethylamino)propyl)imino)bis-2-propanol, N-[2-[2-(dimethylamino)ethoxy]ethyl]-N-methyl-1,3-propanediamine and 3-dimethylaminopropylamine.

Preferably, component A4 is present in a proportion of 0.5 to 15 parts by weight, based on the sum of the parts by weight of all components A=100 parts by weight.

### Component B

Aliphatic, cycloaliphatic, araliphatic, aromatic and heterocyclic polyisocyanates are used as component B, for example those corresponding to formula (II)

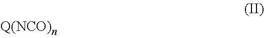

wherein n is an integer between 2-4, preferably 2 or 3, and Q is an aliphatic hydrocarbon radical having 2-18, preferably 6-10 C atoms, a cycloaliphatic hydrocarbon radical having 4-15, preferably 6-13 C atoms, an aromatic hydrocarbon radical having 6-10 C atoms, or an araliphatic hydrocarbon radical having 8-15, preferably 8-13 C atoms.

Particularly preferred are usually the technically easily accessible polyisocyanates, e.g. the 2,4- and 2,6-toluylene diisocyanate, as well as any mixtures of these isomers (“TDI”); polyphenylpolymethylene polyisocyanates as prepared by aniline-formaldehyde condensation followed by phosgenation (“crude MDI”) and carbodiimide groups, urethane groups, allophanate groups, isocyanurate groups, urea groups or biuret groups (“modified polyisocyanates”), in particular such modified polyisocyanates which differ from 2,4- and/or 2,6-toluylene diisocyanate and/or from 4,4′- and/or 2,4′-diphenylmethane diisocyanate. Preferably, at least one compound selected from the group consisting of 2,4- and 2,6-toluylene diisocyanate, 4,4′- and 2,4′- and 2,2′-diphenylmethane diisocyanate and polyphenylpolymethylene polyisocyanate (“multinuclear MDI”) is used as component B.

The mixtures of diphenylmethane diisocyanate and polyphenylene polymethylene polyisocyanate (“multinuclear MDI” or “pMDI”) have a preferred monomer content of between 50 and 100 wt. %, preferably between 60 and 95 wt. %, particularly preferably between 75 and 90 wt. %. The NCO content of the polyisocyanate used should preferably be above 25 wt. %, preferably above 30 wt. %, particularly preferably above 31.4 wt. %. Preferably, the MDI used should have a 2,4′-diphenylmethane diisocyanate content of at least 3% by weight, preferably at least 15% by weight.

In addition to the polyisocyanates mentioned above, modified diisocyanates containing uretdione, isocyanurate, urethane, carbodiimide, uretonimine, allophanate, biuret, amide, iminooxadiazinedione and/or oxadiazine trione groups as well as non-modified polyisocyanate with more than 2 NCO groups per molecule, such as 4-isocyanatomethyl-1,8-octane diisocyanate (nonantriisocyanate) or triphenylmethane-4,4′,4″-triisocyanate.

The isocyanate index (also called isocyanate index) is the quotient of the actual amount [mol] of isocyanate groups used and the actual amount [mol] of isocyanate reactive groups used, multiplied by 100:

Index=(moles of isocyanate groups/moles of isocyanate-reactive groups)*100

In the reaction mixture the number of NCO groups in the isocyanate and the number of isocyanate-reactive groups may result in an index of 60 to 250, preferably between 70 and 130 and particularly preferably between 75 and 120.

The NCO value (also known as NCO content, isocyanate content) is determined according to EN ISO 11909:2007. Unless otherwise stated, values at 25° C. are concerned.

For the production of the polyurethane foams according to the invention, the reaction components are brought to reaction by the single-stage process, the prepolymer process or the semi-prepolymer process, which are known per se, and machine equipment known to the person skilled in the art is often used.

Preferred polyurethane foams are flexible polyurethane foams which are produced as molded foams or also as slabstock foams, whereby the molded foams can be produced by hot-curing or also cold-curing.

The polyurethane foams obtainable according to the invention find the following applications, for example: Furniture upholstery, textile inserts, mattresses, automobile seats, headrests, armrests, sponges and structural elements, as well as seat and fitting trim, and can have bulk densities of 4 to 600 kg/m³, preferably 60 to 120 kg/m³ (semi-rigid foam) or preferably 15 to 55 kg/m³ (flexible foam).

In a preferred embodiment of the invention, the invention relates to a process for the production of polyurethanes, preferably polyurethane foams, wherein the components
A1 containing compounds having hydrogen atoms reactive to isocyanates
   A1.1 29 to 70 parts by weight (based on the sum of the parts by weight of all components A=100 parts by weight) of compounds containing hydrogen atoms reactive toward isocyanates and having an NH and/or OH number according to DIN 53240-1 in the version of June 2013 of 20 to <120 mg KOH/g,
   A1.2 from 0 to 30 parts by weight (based on the sum of the parts by weight of all components A=100 parts by weight) of compounds containing isocyanate-reactive hydrogen atoms and having an NH and/or OH number according to DIN 53240-1, as amended in June 2013, of from 120 to <600 mg KOH/g,
   A1.3 from 0 to 10 parts by weight (based on the sum of the parts by weight of all components A=100 parts by weight) of compounds containing hydrogen atoms reactive toward isocyanates and having an NH and/or OH number according to DIN 53240-1, as amended in June 2013, of from 600 to 4000 mg KOH/g,
A2 blowing agents containing
   A2.1 0.1 to 10 parts by weight, preferably 1 to 5 parts by weight (based in each case on the sum of the parts by weight of all components A=100 parts by weight), chemical blowing agents such as water and/or
   A2.2 0 to 15 parts by weight (based on the sum of the parts by weight of all components A=100 parts by weight) of physical blowing agents such as CO2,
A3 Flame retardants
   A3.1 0.1 to 50 parts by weight of particles consisting of a core comprising water-soluble ammonium polyphosphate and a shell comprising polyphenols,
   A3.2 0 to 20 parts by weight of further flame retardants, preferably melamine and TCPP,
A4 0.5 to 10 parts by weight (based on the sum of the parts by weight of all components A=100 parts by weight) of auxiliaries and additives such as
   a) catalysts,
   b) surface-active additives,
   c) pigments, and
B di- and/or polyisocyanates containing >65% by weight of difunctional isocyanates,
   are reacted with one another.

### BRIEF DESCRIPTION OF THE FIGURES

FIG. 1 shows a schematic picture of a method according to the invention resulting in a dispersion comprising the particles in an isocyanate-reactive matrix.

FIG. 2 shows a DLS graph of particles with an APP core and a lignin shell (LP) in cyclohexane (average from 3 measurements, Z-average=240 nm, PDI=0.13).

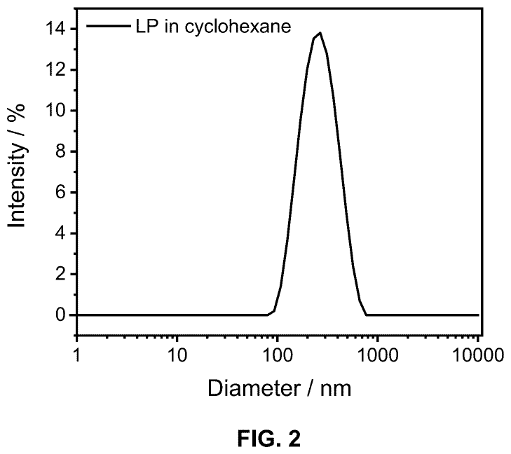

FIG. 3 shows electron microscopy images of LP (left: SEM, right: TEM).

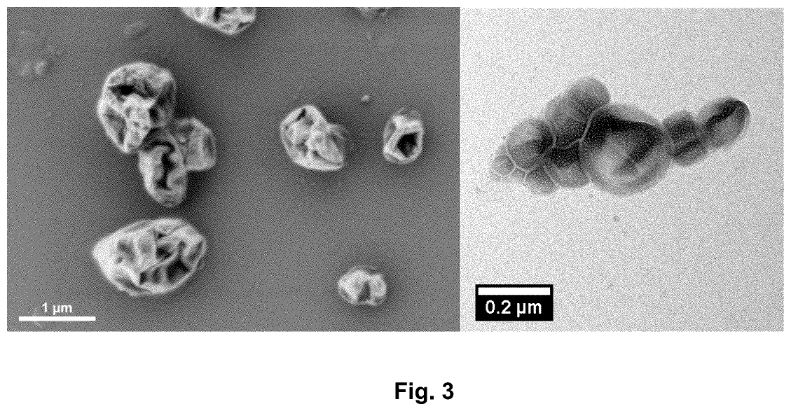

### DETAILED DESCRIPTION OF THE INVENTION

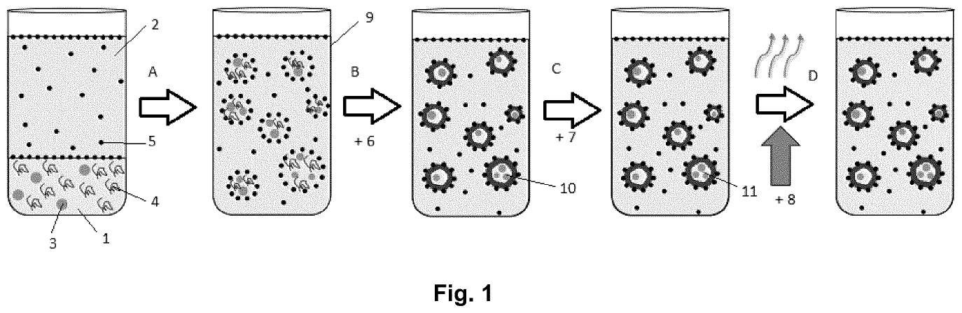

In FIG. 1, a two-phase mixture is prepared from polyphenols 4 and water-soluble flame retardant 3 in water 1, and emulsifier 5 in organic solvent 2. In step A, the two-phase mixture is emulsified to form an inverse emulsion 9. In step B, cross-linker 6 is added to form particles 10. In step C, functionalized monomer, oligomer or polymer 7 is added to form functionalized particles 11. Finally, in step D the compound with hydrogen atoms which are reactive towards isocyanates 8 is added and the solvent is evaporated to form a dispersion comprising the particles in an isocyanate-reactive matrix.

### Examples

### Particle Synthesis

### Raw Materials

Lignosulfonate (TCI, Prod. No.: L0098, #V5VJF-NC), ammonium polyphosphate (APP111, water soluble, Connect Chemicals GmbH, Germany), polyglycerol polyricinoleate (Grinsted PGPR, Danisco, #4012754390, Mat.: 033624), cyclohexane (≥99%, VWR), toluene-2,4-diisocyanate (≥95%, TDI, Sigma Aldrich), toluene (≥99.5%, VWR).

### Equipment

Microfluidizer LM10, Branson ultrasonic tip SFX 550, Malvern Zetasizer Lab, rotary evaporator Buchi R200 equipped with a membrane or an oil pump (Büchi V-500 or Edwards RV3), dynamic light scattering Malvern Zetasizer Lab, centrifuges (Hermle Z36HK and Phoenix CD-3124R), scanning electron microscope Hitachi SU8400, transmission electron microscope Zeiss EM91, vacuum oven VOS-12051 (VOS instrumenten) equipped with membrane pump KNF PM23973-920, autoclave HMC Hiclave HG50 (HMC Europe GmbH, Germany).

### PGPR Purification

Optionally, PGPR was purified from insoluble aggregates before usage. Therefore, 120 g of PGPR was dissolved in 600 mL of cylcohexane in a 1 L round bottom flask at room temperature. The PGPR solution was then transferred to four 250 mL centrifuge bottles, tared and centrifuged at 9000 rpm for 10 min. The colorless pellet was discarded. The clear supernatant was transferred to a 1 L round bottom flask. The cyclohexane was then completely removed from the solution with a rotary evaporator (40° C., 140 mbar). A clear yellow viscous liquid was obtained.

Dispersion of Particles with an APP Core and Lignin Shell in Cyclohexane

In a 1 L laboratory bottle, the aqueous phase consisting of 15 g lignosulfonate in 195 g water was prepared. After the lignosulfonate was completely dissolved at room temperature, the solution was autoclaved at 121° C. for 40 min and removed from the autoclave. Then, 36 g of ammonium polyphosphate was added to the lignosulfonate solution and dissolved at room temperature. The pH of the water phase was adjusted to pH 8 by adding NaOH to the APP/lignosulfonate solution. Afterwards, the organic phase consisting of 12 g of purified PGPR and 587 g of cyclohexane was added. Subsequently, the two-phase mixture was pre-emulsified on a Branson SFX 250 ultrasonic tip (2 min, 70% amplitude, 30 s sonication, 10 s pause). Any macroscopic precipitates from the pre-emulsion were separated by filtration through an open-pored filter paper. Subsequently, emulsification was performed with the LM10 microfluidizer (6000 psi, 4 runs). This yielded in droplet sizes of 200 nm with a PDI=0.1. The emulsion was then transferred to a 2 L flask and stirred at 500 rpm using a magnetic stirring bar. Freshly prepared crosslinker solution consisting of 3.6 g TDI in 182.9 mL of the organic solvent (cyclohexane or toluene) and 1.7 g purified PGPR was added via a 500 mL dropping funnel (approximately 2 drops per second). The dispersion was then stirred at room temperature overnight at 600 rpm using an elliptical stir bar. The next day, stirring was stopped for 2 h and any sedimenting flocculation were decanted and the dispersion was stored in a laboratory bottle, subsequently.

Dispersion of Particles with an APP Core and Lignin Shell in Polyol Matrices

### Raw Materials

A1.1-1: Trifunctional copolymer of propylene oxide and ethylene oxide with a molecular weight Mn of 3 kg/mol (Arcol® polyol 1105S, Covestro AG, Germany)
A2.1-1: Water
A3.1-1: Dispersion of 14 wt % lignin/TDI-coated ammonium polyphosphate (APP) in A1.1-1.
A3.2-1: Trichloropropyl phosphate (TCPP)
A3.2-2: Melamine
A4-1: Dabco NE300 (Evonik)
A4-2: stannous octoate
A4-3: 33% by weight of triethylenediamine in dipropylene glycol
A4-4: Tego rod B8239
B-1: Mixture of 2.4 and 2.6 TDI in a ratio of 80:20 (Desmodur T80)

200 g of A1.1-1 was dissolved in 590 g of cyclohexane at room temperature. Based on the measured solid content of the particle dispersion in cyclohexane, which was 5.70 wt. % and a targeted particle amount of 14 wt. % in the final composition, 570 g of particle dispersion in cyclohexane was placed in a 2 L flask and stirred at 500 rpm with a stirring bar. The polyol solution was slowly added to the dispersion via a 500 mL dropping funnel (one drop per second). After the polyol solution was added, the dispersion was stirred at room temperature overnight at 500 rpm.

The next morning, the solvent was slowly distilled from the dispersion at 40° C. at a rotary evaporator. Starting at 250 mbar, the pressure was continuously reduced over several hours to finally 30 mbar. Any remaining solvent residues could be removed subsequently by applying an oil pump vacuum (0.01 mbar, overnight). The distillate contained the organic solvent and water. The organic solvent was separated from the water phase via a separating funnel and recycled.

To produce the polyurethane foams, the necessary amount of component A was placed in a paper cup with a metal bottom (volume: approx. 850 ml) and stirred with a stirrer (Pendraulik) with a standard stirring disk (d=64 mm) at 4200 rpm for 45 seconds loaded with air. Then component B was added to component A and the mixture was intensively mixed with a stirrer for 5 seconds. The exact composition of the individual components is shown in Table 1. A stopwatch was started at the beginning of the mixing to determine the characteristic reaction times. The reaction mixture was then poured into a paper-lined wooden box mold with a volume of 0.3*0.3*0.2 dm3 and a temperature of 20° C. The foam rose freely.

All test specimens were cut out of the core of the freely foamed foam bodies.

### Characterization

### Solid Content of Lignin Particles (LP) Dispersion

200 μL of dispersion of particles with an APP core and lignin shell in cyclohexane was placed into 1 mL glass vials and the solvent was evaporated under vacuum (2 h, 70° C.). Subsequently, the solid content was determined by differential weighing. Typically, solid contents of 5.7±0.3% were reached.

### Dynamic Light Scattering (DLS)

Particle size was measured with a Malvern Zetasizer Lab at a scattering angle of 90° at 25° C. using a general purpose analysis model. 2.5 μL particle dispersion was diluted in 800 μL fresh cyclohexane in a glass cuvette so that the attenuator was at step 10-11 (set automatically by the device). Data analysis was done with ZSxplorer 2.2.0.147 software from Malvern Panalytical. Three measurements were performed for each sample.

### Electron Microscopy of Particles

500 μL of dispersion was centrifuged three times at 1400 g for 30 min in a 1 mL microreaction tube. After each centrifugation, the supernatant was removed and the resulting pellet was redispersed in 500 μL of fresh cyclohexane (30 s vortex and 15 min ultrasonic bath). After the last redispersion, 10 μL of the sample was diluted in 800 μL of fresh cyclohexane. 2 μL of this diluted sample was placed onto a Si wafer, the solvent was evaporated overnight at room temperature. The particles were imaged via SEM subsequently. For TEM imaging, 1 μL of the diluted sample was dropped onto a copper grid and the solvent was evaporated at room temperature.

### Cone Calorimetry

The fire properties of the polyurethane foams were measured in the cone calorimeter according to ISO 5660-1 on samples of 3*10*10 cm³ with an irradiation power of 25 kW/m² for 600 seconds by the fire technology laboratory of Currenta GmbH & Co. KG in Cologne according to ISO 5660-1 in the most recent version.

here is
MARHE the maximum of the mean heat release in kW/m²,
HRR(peak) the maximum heat release in kW/m²,
THR the total heat release in MJ/m²,
TML the total mass loss in grams over 600 seconds of irradiation and
TSR total smoke production over 600 seconds exposure.

The hydroxyl number was determined in accordance with DIN 53240-1 in the June 2013 version.

### Further Test Methods

To measure the storage stability, 100 mL of dispersion A3.1-1 were stored motionless at 25° C. for 2 months. The top 25 mL of the dispersion were then removed using a pipette (sample 1). Then the next 50 mL are removed and discarded. The remainder of 25 mL is Sample 2. The weight of Sample 1 and Sample 2 is determined. In the case of dispersions according to the invention, the weights of sample 1 and sample 2 differ by no more than 25%.

The core density of the polyurethane foams was measured in accordance with DIN EN ISO 845 in the October 2009 version. The compression hardness of the foams was determined at 40% deformation in accordance with DIN EN ISO 3386-1 in the September 2010 version.

TABLE 1
Formulation and properties of the polyurethane foams

| Example | | CE1* | CE2* | CE3* | 1 | 2 |
|---|---|---|---|---|---|---|
| A3.1-1 | ppw | 0 | 0 | 0 | 25.1 | 24.3 |
| A1.1-1 | ppw | 51.3 | 58.9 | 48.6 | 23.3 | 22.6 |
| A2.1-1 | ppw | 2.3 | 2.7 | 2.7 | 1.8 | 2.9 |
| A4-1 | ppw | 0 | 0 | 0 | 0 | 0.05 |
| A4-2 | ppw | 0.1 | 0.2 | 0.1 | 0.3 | 0.4 |
| A4-3 | ppw | 0.1 | 0.1 | 0.1 | 0.2 | 1.1 |
| A4-4 | ppw | 0.3 | 0.4 | 0.3 | 0.3 | 0.3 |
| A3.2-1 | ppw | 5.1 | 5.9 | 4.9 | 4.7 | 4.5 |
| A3.2-2 | ppw | 12.8 | 0 | 12.2 | 9.9 | 9.6 |
| B-1 | ppw | 27.7 | 31.8 | 31.0 | 34.4 | 34.2 |
| Index | | 102 | 102 | 102 | 102 | 102 |
| APP particles | g/kg | | | | 40 | 39 |
| | total | | | | | |
| Total solids | g/kg | 128 | 0 | 122 | 139 | 135 |
| | total | | | | | |
| Total chlorine from | g/kg | 17 | 19 | 16 | 15 | 15 |
| TCPP | total | | | | | |
| Core density | kg/m³ | 33 | 28 | 30 | 45 | 29 |
| Compressive strength | kPa | 5.9 | 4.6 | 6.5 | 12.6 | 6.1 |
| Compressive strength | kPa | 4.9 | 5.3 | 6.5 | 5.6 | 6.5 |
| corrected to 30 kg/m³ | | | | | | |
| Fire properties | | | | | | |
| MARHE | kW/m² | 217 | 248 | 232 | 155 | 182 |
| HRR (peak) | kW/m² | 343 | 343 | 342 | 236 | 236 |
| THR/TML | MJ/g*m² | 2.6 | 2.6 | 2.6 | 2.6 | 2.5 |
| TSR/TML | m²/g*m² | 32 | 46 | 30 | 32 | 33 |

*Comparative example

The compressive strength is measured at 40% compression (4th cycle). For the correction to 30 kg/in³ a quadratic dependency was assumed.

In Comparative Example 2, a particle-free polyurethane foam is prepared as a reference with the addition of TCPP as the sole flame retardant. The polyurethane foam obtained has some of the highest values in fire properties for smoke generation (TSR/TML), maximum averaged heat release (MARHE) and maximum heat release (HRR(peak)). When melamine is added as another flame retardant additive in Comparative Examples 1 and 3, the fire properties are improved in terms of smoke evolution and MARHE value. Partial replacement of melamine by the flame retardant A3.1 used according to the invention does not change the fundamental fire behaviour of the foam as illustrated by the THR/TML and smoke values but it results in polyurethane foams with improved immediate reaction to fire as illustrated by the decreased peak heat release rate and decreased MARHE values.

The experiments of example 1 and 2 are repeated with larger particles (10 μm as measured by TEM). This results in higher MARHE and HRR values and lower compressive strength.

The invention furthermore relates to the following clauses:

1. Particles comprising a core comprising a water-soluble ammonium polyphosphate and a shell comprising polyphenols, preferably bio-based polyphenols.

2. Particles according to clause 1, characterized in that the amount of the core of the particles amounts to 65-95% by weight and the amount of the shell amounts to 5-35% by weight, based on the total weight of the core and the shell of the particles.

3. Particles according to clause 1 or 2, characterized in that the ammonium polyphosphate of the core of the particles corresponds to formula (I).

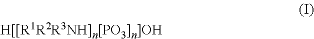

wherein R¹ to R³ independently represent H or a substituted or unsubstituted alkyl group, preferably an alkyl group having 1 to 8 carbon atoms, and
n is an integer from 4 to 20.

4. Particles according to any one of clauses 1 to 3, wherein the core comprises, in addition to ammonium polyphosphate, at least one further compound selected from the group consisting of phosphates, phosphinates and/or phosphonates.

5. Particles according to one of clauses 1 to 4, wherein the shell of the particles comprises polyphenols which comprise structural units derived from lignin, preferably structural units derived from lignosulfonate, more preferably lignosulfonates which have a water solubility at a pH between 6.0 and 8.0 of at least 5 wt. %, and/or which have at least 8 mmol/g of hydroxyl groups.

6. Particles according to any one of clauses 1 to 5, wherein the shell of the particle is substantially free from melamine, acrylate and hydrophobic silicone.

7. Dispersion comprising particles according to any one of clauses 1 to 6 in an isocyanate-reactive matrix.

8. Method for producing particles according to any one of clauses 1 to 6, comprising
preparing an inverse emulsion of polyphenols, ammonium polyphosphate, emulsifier and water in an organic solvent, and subsequently
cross-linking the polyphenol with a crosslinker,
optionally followed by removing the organic solvent.

9. Use of particles according to any one of clauses 1 to 6 as flame retardants.

10. Method for producing polyurethane foams, wherein the components
A comprising
   A1 one or more compounds with hydrogen atoms which are reactive towards isocyanates,
   A2 a blowing agent,
   A3 a flame retardant, and optionally
   A4 an excipient and/or additive
and
B a polyisocyanate,
are reacted with one another, wherein the flame retardant A3 comprises particles according to any one of clauses 1 to 6 as component A3.1.

11. Method according to clause 10, wherein in addition to component A3.1, at least one further flame retardant is used as component A3.2.

12. Method according to clause 11, wherein component A3.2 contains melamine.

13. Method according to any one of clauses 10 to 12, wherein component A3 does not comprise a halogen-containing compound.

14. Polyurethane foam produced by the method according to any one of clauses 10 to 13.

15. Use of a polyurethane foam according to clause 14 for the production of furniture upholstery, textile inserts, mattresses, automobile seats, headrests, armrests, sponges, headliners, door panels, seat covers or construction elements.

What is claimed is:

1. Particles, comprising:
a core comprising a water-soluble ammonium polyphosphate, and
a shell comprising polyphenols, preferably bio-based polyphenols,
wherein the particles have a size of between 100 nm-1 μm as measured by DLS, and
wherein the water-soluble ammonium polyphosphate has a water solubility of at least 1 g/mL @ 25° C.

2. The particles according to claim 1, wherein the amount of the core of the particles amounts to 65-95% by weight and the amount of the shell amounts to 5-35% by weight, based on the total weight of the core and the shell of the particles.

3. The particles according to claim 1, wherein the ammonium polyphosphate of the core of the particles corresponds to formula (I), 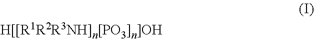
wherein
R¹ to R³ independently represent H or a substituted or unsubstituted alkyl group, preferably an alkyl group having 1 to 8 carbon atoms, and
n is an integer from 4 to 20.

4. The particles according to claim 1, wherein the core comprises, in addition to ammonium polyphosphate, at least one further compound selected from the group consisting of phosphates, phosphinates and/or phosphonates.

5. The particles according to claim 1, wherein the shell of the particles comprises polyphenols which comprise structural units derived from lignin, preferably structural units derived from lignosulfonate, more preferably lignosulfonates which have a water solubility at a pH between 6.0 and 8.0 of at least 5 wt. %, and/or which have at least 8 mmol/g of hydroxyl groups.

6. The particles according to claim 1, wherein the shell of the particle is substantially free from melamine, acrylate and hydrophobic silicone.

7. A dispersion comprising the particles according to claim 1 in an isocyanate-reactive matrix.

8. A method for producing particles according to claim 1, comprising:
preparing an inverse emulsion of polyphenols, ammonium polyphosphate, emulsifier and water in an organic solvent, and subsequently
cross-linking the polyphenol with a crosslinker,
optionally followed by removing the organic solvent.

9. A use of particles according to claim 1 as flame retardants.

10. A method for producing polyurethane foams, wherein the components
A comprising
A1 one or more compounds with hydrogen atoms which are reactive towards isocyanates,
A2 a blowing agent,
A3 a flame retardant, and optionally
A4 an excipient and/or additive
and
B a polyisocyanate,
are reacted with one another, wherein the flame retardant A3 comprises particles according to claim 1 as component A3.1.

11. The method according to claim 10, wherein in addition to component A3.1, at least one further flame retardant is used as component A3.2.

12. The method according to claim 11, wherein component A3.2 contains melamine.

13. The method according to claim 10, wherein component A3 does not comprise a halogen-containing compound.

14. A polyurethane foam produced by the method according to claim 10.

15. A use of a polyurethane foam according to claim 14 for the production of furniture upholstery, textile inserts, mattresses, automobile seats, headrests, armrests, sponges, headliners, door panels, seat covers or construction elements.

16. The particles according to claim 1 wherein the amount of the core of the particles amounts to 65-95% by weight and the amount of the shell amounts to 5-35% by weight, based on the total weight of the core and the shell of the particles and wherein the ammonium polyphosphate of the core of the particles corresponds to formula (I), 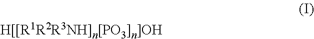
wherein
R¹ to R³ independently represent H or a substituted or unsubstituted alkyl group, preferably an alkyl group having 1 to 8 carbon atoms, and
n is an integer from 4 to 20,
and wherein the core comprises, in addition to ammonium polyphosphate, at least one further compound selected from the group consisting of phosphates, phosphinates and/or phosphonates and wherein the shell of the particles comprises polyphenols which comprise structural units derived from lignin, preferably structural units derived from lignosulfonate, more preferably lignosulfonates which have a water solubility at a pH between 6.0 and 8.0 of at least 5 wt. %, and/or which have at least 8 mmol/g of hydroxyl groups and wherein the shell of the particle is substantially free from melamine, acrylate and hydrophobic silicone.

17. The dispersion comprising particles according to claim 16 in an isocyanate-reactive matrix.

18. The method for producing particles according to claim 16, comprising:
preparing an inverse emulsion of polyphenols, ammonium polyphosphate, emulsifier and water in an organic solvent, and subsequently
cross-linking the polyphenol with a crosslinker,
optionally followed by removing the organic solvent.

19. The use of particles according to claim 16 as flame retardants.

20. The method according to claim 10, wherein in addition to component A3.1, at least one further flame retardant is used as component A3.2 and wherein component A3.2 contains melamine and wherein component A3 does not comprise a halogen-containing compound.

21. The polyurethane foam produced by the method according to claim 20.

22. The use of a polyurethane foam according to claim 21 for the production of furniture upholstery, textile inserts, mattresses, automobile seats, headrests, armrests, sponges, headliners, door panels, seat covers or construction elements.
